(19) United States
(12) Patent Application Publication
(10) Pub. No.: US 2006/0180547 A1
(43) Pub. Date: Aug. 17, 2006

(54) PROCESS AND HYBRID REACTOR FOR THE PROCESSING OF RESIDUAL WASTE

(75) Inventors: Christian Widmer, Binningen (CH); Martin Schmied, Meinertshagen (DE); Thomas Engelhard, Au am Rhein (DE)

Correspondence Address: OLIFF & BERRIDGE, PLC, P.O. BOX 19928, ALEXANDRIA, VA, 22320, US

(73) Assignee: ISKA GMBH, Ettlingen (DE)

(21) Appl. No.: 10/549,675

(22) PCT Filed: Mar. 17, 2004
(86) PCT No.: PCT/DE04/00546

§ 371 Date: Mar. 21, 2006

(30) Foreign Application Priority Data
Mar. 17, 2003 (DE) 103 11 904.3
Jan. 22, 2004 (DE) 10 2004 003 458.3

(51) Int. Cl. C02F 9/00

(52) U.S. Cl. 210/631

(57) ABSTRACT

What is disclosed is a process for mechanical and biological processing of waste substances, in particular of residual waste, wherein a physico-chemical processing (PCP) for the denitrificaton of a process water freed from organic constituents is provided, as well as a hybrid reactor comprising a solid bed, sludge discharge means, and means for destroying a surface scum.

The invention relates to a process and a hybrid reactor for processing waste substances, in particular residual waste in accordance with the preambles of claims 1 and 21, respectively.

A like process is known, e.g., from PCT/EP02/09855. One problem in this waste processing process is the processing of the process water used in the biological processing which is freighted with organic matter that must be removed prior to introduction into a processing plant/sewer. It is desired to manage the process water in a circuit, wherein the process water fraction that is freed from organic matter is returned to the biological processing as circuit water.

It was found, however, that in the conventional solutions it is only possible with considerable expense in terms of process technology to attain minimum concentrations of organic matter constituents the process water lower than those required in order to smoothly carry out the process and specified by regulations.

In view of this, it is the underlying object of the invention to furnish a process and a hybrid reactor for processing waste substances, wherein processing of the process water is simplified in comparison with conventional solutions.

In accordance with the invention, this object is achieved through a process having the features of claim 1 and a hybrid reactor having the features of claim 21.

Accordingly, the process contains a process water processing step in which a denitrificaton of the process water freed from organic matter takes place, so that this denitrified process water may again be supplied to the process or to a further processing.

Such denitrificaton is preferably carried out in a stripper means comprising a stripper column into which air is blown in in a counter-flow to the injected process water, and which is followed downstream by a catalyst column for converting the ammonia gas into nitrogen.

Another alternative provides a stripper means comprising a stripper column into which saturated vapor is injected in a counter-flow to the injected process water, and which is followed downstream by a cooler for condensing the exiting vapor mixture.

Optionally it is possible to combine several stripper means of one or several types.

The efficiency of the process may be improved further by adding lye upstream of the stripper means. As a result of this lye, the pH value of the process water is raised and ammonia gas is dissolved in the process water.

By the process water processing in accordance with the invention it is possible to treat turbid water or water discharged from a percolation, a pulper, or an anaerobic process. Previously it had been necessary to individually adapt the process water processing method to the type of the biological processing of the waste substance.

The proportion of solids in the process water may be further reduced by ultrafiltration. This ultrafiltration may have associated a precipitation of chlorides, phosphates, etc.

The biological process water processing preferably is carried out with the aid of a hybrid reactor having a sludge discharge device at its bottom, and means for destroying a forming surface scum at its head.

For a desulfurization of the forming biogas, air or oxygen may be injected into the head of the reactor.

In order to improve the metabolization process, the hybrid reactor may be provided with means for pressing in gas whereby the forming bed of sludge is periodically subjected to a pressure.

At particular process conditions it is advantageous if a part of the solids is separated off by a flotation.

In particular it is advantageous if the process water freighted with organic matter is subjected to sand washing in the hybrid reactor prior to the processing.

Sand washing may be followed by sand sedimentation and precipitation means in order to filter off the remaining micro-fine sand and to not carry out a precipitation of salts, inert substances, etc. in the hybrid reactor.

Solids, floating matter, and fibrous substances may be separated off in a sifting stage.

The physico-chemical processing (PCP) subsequent to processing of the process water in the hybrid reactor may comprise a reverse osmosis for separating turbid water, salts, etc. from the process water.

In the following, preferred embodiments of the invention shall be explained in more detail by referring to schematic representations, wherein:

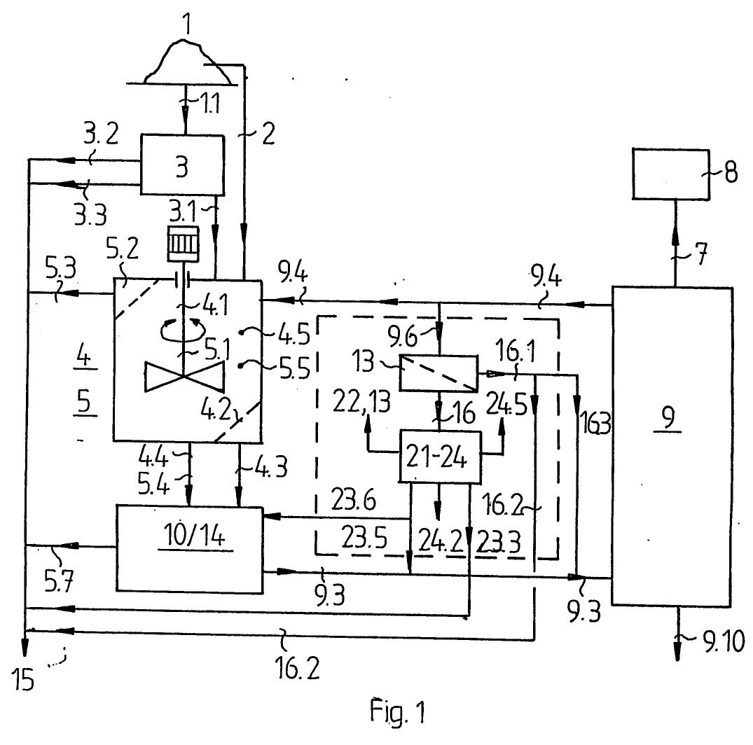

FIG. 1 shows a basic model of a process for aerobic residual waste processing including a percolation or pulper plant,

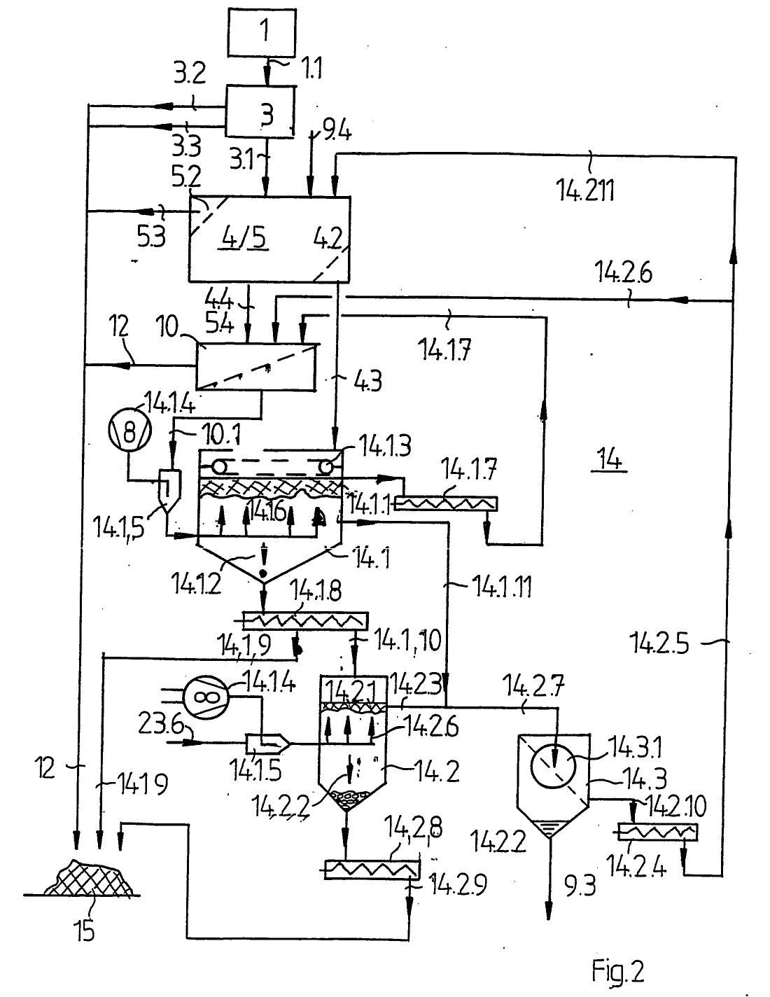

FIG. 2 shows a solids and water treatment in the case of percolation or pulping with subsequent separating steps,

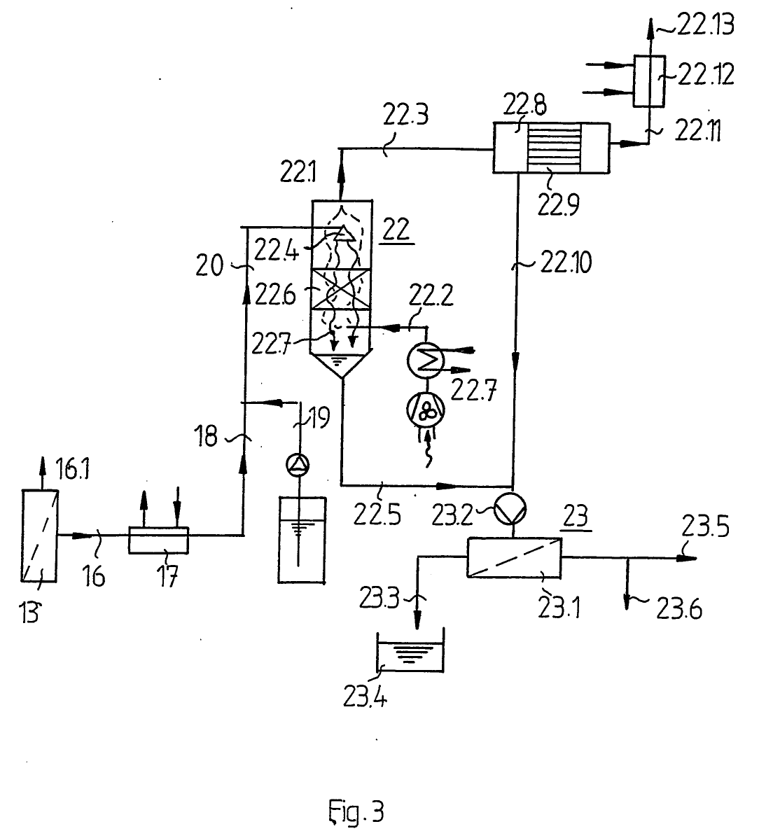

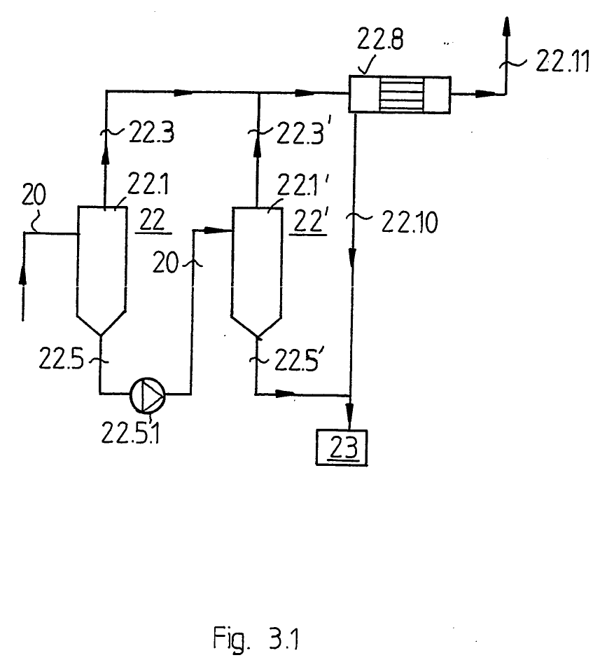

FIG. 3 shows a first embodiment of a PCP plant,

FIG. 3.1 shows a sequential arrangement of two stripper columns after the first PCP waste water treatment,

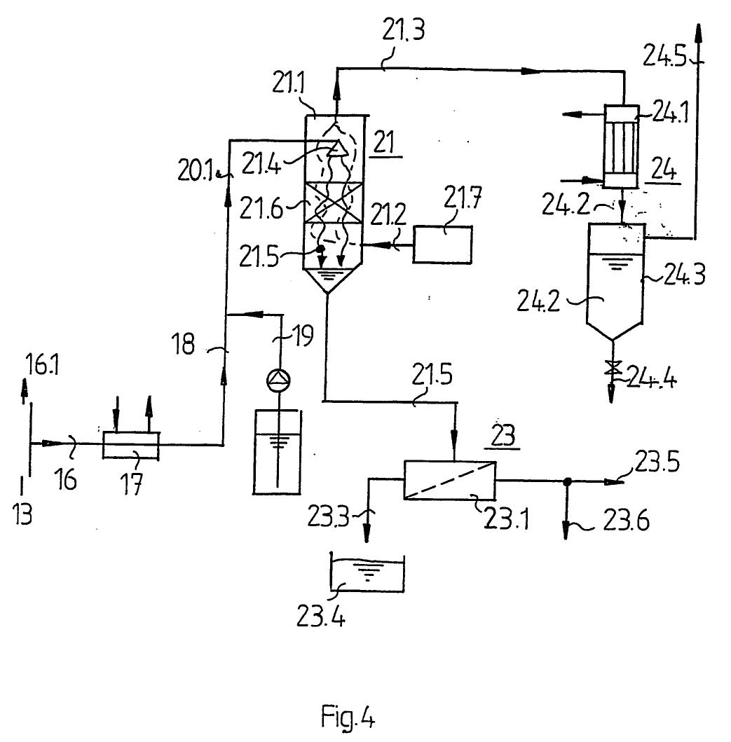

FIG. 4 shows a second embodiment of a PCP plant,

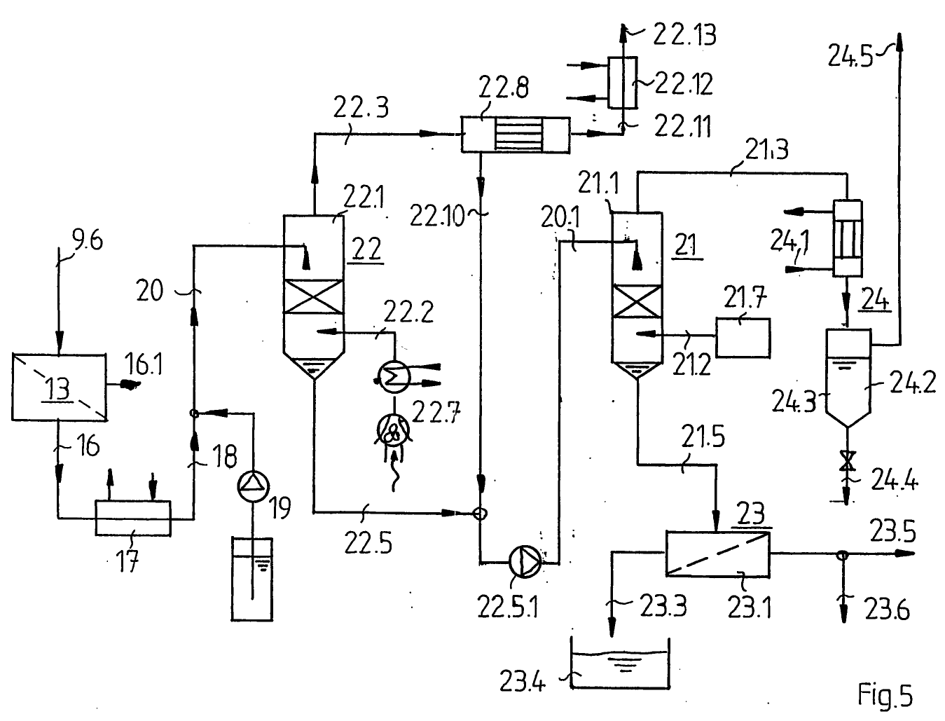

FIG. 5 shows a combination of the concepts in accordance with FIGS. 3 and 4,

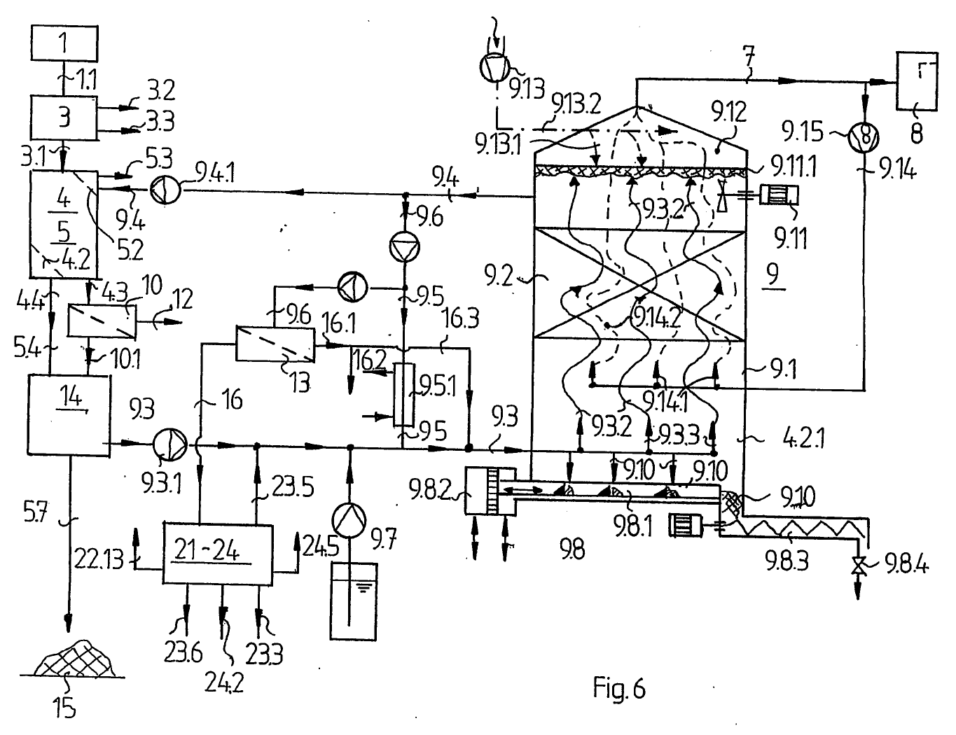

FIG. 6 is an overall view of a model process for residual waste processing including a hybrid reactor,

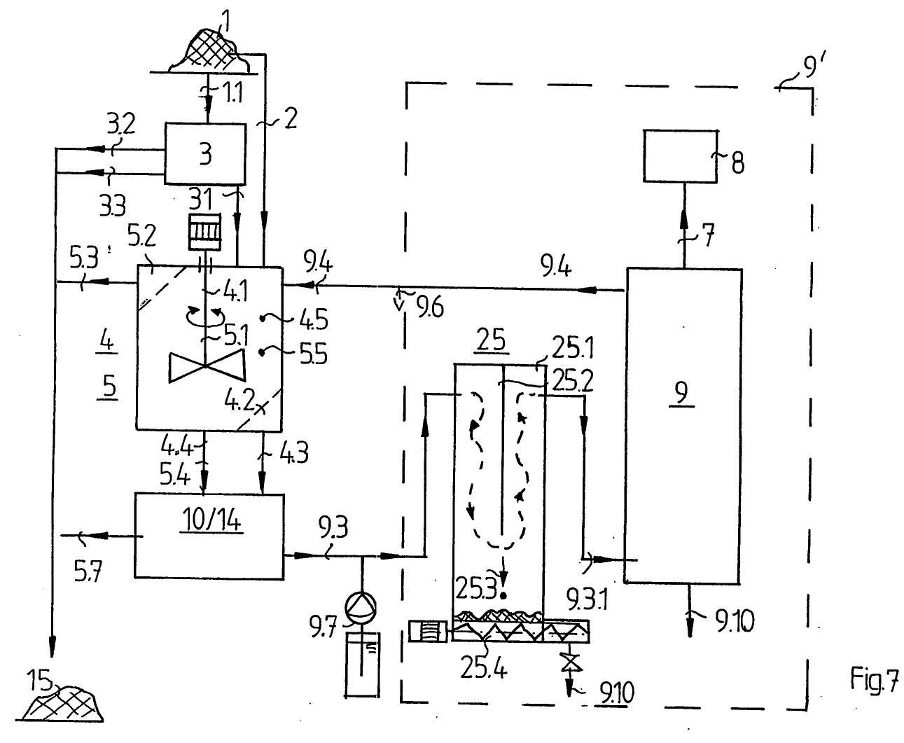

FIG. 7 shows a hybrid reactor with upstream sand sedimentation and a precipitation reactor,

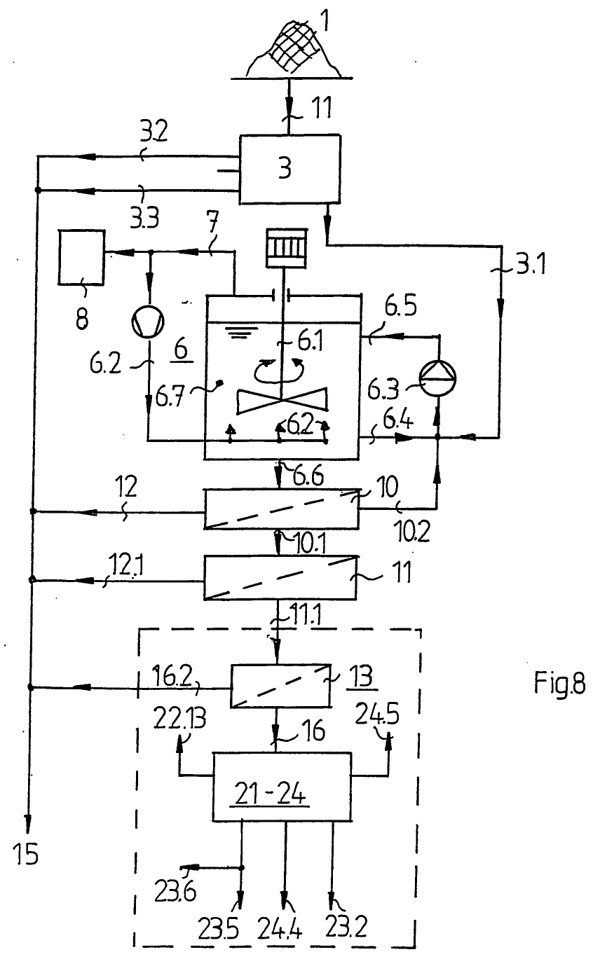

FIG. 8 is a partial view of a model process for anaerobic residual waste processing including a fermentation plant, and

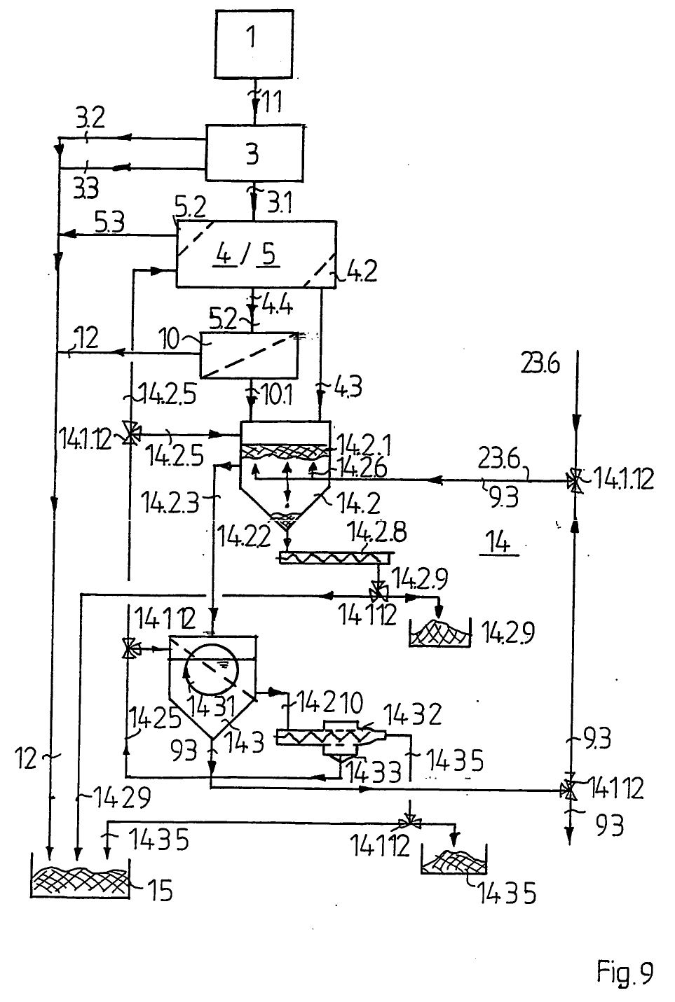

FIG. 9 shows a variant of the process represented in FIG. 2.

FIG. 1 shows a model process for the aerobic processing of polluted waste substances having in particular a dry substance content (DS content) of 50% to 65%, such as, e.g., residual waste, catering wastes, wastes from the food industry, vegetables, and other replenishing organic waste substances, sewage and fermentation sludge, and biological residues from the manufacture of beverages, such as mashes.

The organically charged substances 1 are supplied either through a direct supply 2 or via an upstream mechanical processing plant 3 to a percolation plant 4 or to a pulper plant 5.

Mechanical processing 3 includes the working steps of sifting, sorting and comminuting, wherein the sifting fraction 3.1 is preferably supplied to a percolation plant 4 for particle sizes of 50 mm to 250 mm and preferably to a pulper plant 5 for particle sizes of >250 mm. In the case of a sifting fraction 3.1 having a maximum particle size of about 50 nm, it is preferably supplied to a dry fermentation plant 6 (FIG. 8). In order to separate out material having a high calorific value and large-surface material such as sheets, cartons and paper, a screen overflow 3.2 is provided. In the same way, means 3.3 for sifting and sorting steps are provided in order to eliminate interfering materials such as, e.g., machine parts, wooden beams, FE and NE metals, as well as inert substances and minerals of various particle sizes. The eliminated solids are subjected to a further treatment 15 or utilization depending on their properties. Thus it is possible, e.g., to return the metal-containing solids to the steel-processing industry, and the wood-type solids to the paper industry, and to store the mineral substances or minerals for deposition on a dump.

The percolation plant 4 may be a percolation plant in accordance with German patent application DE 196 48 731 A1, in which the organic constituents of a waste fraction are washed out in a percolator, and the residue is burnt, for instance, following drying. Moreover it is possible to employ a box percolation plant comprising a horizontally arranged, box-type or cylindrical percolator as disclosed, e.g., in WO 97/27158, as well as a boiling percolation plant in accordance with German patent application DE 101 42 906 A1, according to which a percolator is operated in the boiling range of the process water.

Inside the percolator or receptacle 4.5 a rotary mechanical stirring mechanism 4.1 for circulating and mixing heap material is arranged. Leaching water 9.4 is introduced into the head of the receptacle 4.5, whereby the organic substances are washed out from the heap material, and which is then drawn off in the form of organically highly charged discharge water 4.3 at the foot of the receptacle 4.5. The outlet opening is arranged downstream of a sieve bottom 4.2 so as to prevent solids from exiting.

The solids 4.4 freed from the organic matter are taken out through extraction means from the receptacle 4.5 and supplied to separating steps (FIGS. 2, 9) including a classing press 10 as well as a sink/float separation 14. The discharge water 4.3 is supplied directly to the sink/float separation 14.

The average DS content in the receptacle 4.5 is determined by the quantity of supplied washing water 9.4 and of organically highly charged discharge water 4.3, as well as the dwell time or stay time in the receptacle 4.5, and amounts to about 20% to 35%. The stay time is, in accordance with the plant, 2 h to 50 h.

The alternatively usable pulper plant 5 comprises a pulper vessel 5.5 in which a high-velocity stirring mechanism 5.1. for dragging apart the supplied organically charged substances 1 is arranged. The organic matter in the heap material is solubilized by diluting with washing water 9.4 supplied on the head side and by shear forces induced by the stirring mechanism 5.1.

Large-surface light-density materials 5.3 are discharged for further treatment 15 via mechanical discharge means 5.2 situated on top. The discharge means 5.2 have a fork-type construction and are presently represented as a screen. The solubilized organic matter is discharged with the solids 5.4 through bottom-side extraction means and the classing press 10 and thus supplied to the following sink/float separation 14.

The DS content in the pulper vessel 5.5 is adjusted to 5% to 10% by supplying the washing water 9.4. The solubilization and separation step is about 1 h to 3 h in the pulper plant 5.

The substance flows 5.7 and 9.3 occurring in the classing press 10 and in the sink/float separation 14 are supplied as a residual flow 5.7 to the further treatment 15, and the organically highly charged liquid 9.3 freed from the solids is supplied to a biogas plant 9 (FIGS. 1, 6, 7) in accordance with the invention.

Thus it is possible, for instance, to obtain from the residual flows 5.7 FE and NE metals or utilizable mineral substances and minerals for a deposition on dumps in accordance with particular dumping criteria, e.g., Z2. Moreover it is possible to filter out mixtures rich in organic matter for a further biological treatment such as composting, for instance until an equivalence certification or criteria for dumping on specially implemented dumps are satisfied, and to filter out problem substances for their disposal.

The liquid 9.3 charged with organic matter is supplied to a biogas plant 9 (FIGS. 1, 6, 7) for anaerobic decomposition. There the liquid 9.3 is de-freighted by converting the organic matter proportion by means of methane bacteria, and supplied to a biogas combustion 8 for energy generation by means of a gas generation line 7.

The fermentation water de-freighted of the organic matter exits from the biogas plant 9 and is supplied, in the form of absorptive washing water 9.4, to the washing processes 4, 5 as process water.

A partial flow 9.6 of the washing water 9.4 is supplied to an ultrafiltration 13, and/or a decanter and/or a screen belt press or a mechanical edge filter. Ein solids/water mixture 16.1 thus engendered is supplied to the further treatment 15 in the form of a press cake 16.2 and may partly be admixed to the liquid 9.3 charged with organic matter from the sink/float separation 14 as inoculating sludge 16.3. Press water 16 occurring in the ultrafiltration 13 is supplied to a physico-chemical processing plant (PCP plant) 21, 22, 23, 24 in accordance with the invention for a denitrificaton.

The press water 16 is freed from nitrogen in the PCP plant 21, 22, 23, 24. This engenders substance flows that are either supplied as salt-free water or permeate 23.5 to the liquid 9.3 charged with or organic matter, or to the sink/float separation 14 as purified, salt-free operating water 23.6. Other occurring substance flows, such as ammonia water concentrate 24.2, are stored and used, e.g., for the denitrificaton of large-scale combustion plants such as thermal power plants and waste incineration plants. Occurring solids 23.3 are supplied to the further treatment 15. The waste air 22.13 charged with nitrogen that is present after the PCP and purified water vapor 24.5 are discharged into the environment. A detailed explanation of the denitrificaton in accordance with the invention with an upstream ultrafiltration 13 will be given by referring to FIGS. 3, 3.1, 4 and 5.

FIG. 2 schematically shows a process flow in a percolation or a pulper plant 4, 5 including the downstream separating steps 10, 14 of FIG. 1.

Basically the path of the solids flows 4.4, 5.4 downstream of the percolation plant 4 and the pulper plant 5 is identical. The essential difference is that the percolation plant 4 need not be arranged downstream from the sink/float separation 14 in order to supply the substance flow 4.3 to the biogas plant 9, whereas in the pulper plant 5 the sink/float separation 14 is necessary in order to filter the pulp (solid) from the substance flow 5.4. Hereinafter the sink/float separation 14 is, however, interposed in either process for the purpose of simplification.

It is another difference that discharge water 4.3 to be supplied to the sink/float separation 14 does not occur in the pulper plant 5, but instead light-density materials 5.3 are created that are supplied to the further treatment 15.

Following percolation in the percolator 4, the percolated solid 4.4 is supplied to the classing press 10, and the discharge water 4.3 to the combined flotation or sink/float separation 14. In the classing press 10 the press cake 12 is separated from the waste water 10.1. and supplied to the further treatment 15.

In the pulper process 4, the light-density materials 5.3 are supplied to the further treatment 15, and the solids 5.5 are also supplied to the classing press 10.

The waste water 1.0.1 of the classing press 10 that is freed from rough solids is supplied to a mixer 14.1.5 in which it is mixed with air by means of a ventilator 14.1.4 and subsequently injected at a slight superpressure via bottom-side injection means 14.1.6 into a separation tank 14.1 of the sink/float separation 14. As a result of enriching the waste water 10.1 with air and blowing in at superpressure, the separability and the separation rate are enhanced considerably in comparison with a known pressure relief flotation.

The discharge water 4.3 of the percolator 4 charged with organic matter is supplied on the head side to the separation tank 14.1. where it mixes with the waste water 10.1, and floating matter 14.1.1 and sinking matter 14.1.2 separate out from this water mixture.

The floating matter 14.1.1 floats to the surface to form a scum of floating matter. By means of mechanical means 14.1.3 situated on top, the floating matter 14.1.1 is withdrawn and supplied to the classing press 10 for additional dewatering via a conveying line 14.1.7.

The sinking matter 14.1.2 such as, e.g., sand, pebbles and metal parts, sink to the bottom in the separation tank 14.1 and are withdrawn by means of discharge and transport means 14.1.8. Depending on the purpose of use, they are supplied to a further treatment 15 via a conveying line 14.1.9 or conducted via a conveying line 14.1.10 to a washing stage 14.2 for separating off the sand or the inert substances.

In the washing stage 14.2.4, the sand intended for use as a construction material, e.g., for road construction, is free from the organic matter by ashing out in accordance with deposition regulation Z2. In an advantageously cylindrical and erect vessel having a conical bottom, the sinking matter or sand/liquid mixture 14.1.2 are introduced into the vessel on the head side via the conveying line 14.1.10 and rinsed by means of the purified operating water 23.6 of the PCP plant 21, 22, 23, 24 introduced via introduction means 14.2.6. In order to reduce the consumption of operating water 23.6, air may be admixed in the mixer 14.1.5 to the operating water 23.6 with the aid of a ventilator 14.1.4. The air and the operating water 23.6 may be introduced into the vessel continuously or intermittently, as well as separately from each other.

Here it has been found to be advantageous if a preferably slow-moving stirring mechanism (not shown) is used in the vessel in order to introduce shear forces into the sand/liquid mixture to thus facilitate the separation of the organic matter from the sand.

The sand 14.2.2 sinks down in the vessel while the organic constituents 14.2 float to the surface and are discharged as an organic matter/operating water mixture 14.2.3. The sand freed from the organic matter 14.2.9 is discharged on the bottom side via discharge and conveying means 14.2.8, and used as a construction material or added to the press cake 12 and subjected to the further treatment 15.

The organically highly charged waste water 14.1.11 from the separation tank 14.1. is conducted to a sifting stage 14.3.

In the sifting stage 14.3 the two liquid flows 14.1.11, 14.2.3 charged with organic matter are introduced while mixed with each other via an introduction line 14.2.7. The sifting stage 14.3 preferably comprises a drum screen or oscillating screen 14.3.1 lined on the inside and having a mesh size of about 0.5 mm to 1.5 mm, so that the fibers, residual matter, and plastics particles contained in the liquid flow 14.2.7 are separated out. The pasty mass 14.2.10 thus created is discharged and supplied to the classing press 10 for dewatering via conveyor means 14.2.4 and conveying lines 14.2.5, 14.2.6. As an alternative, the pasty mass 14.2.10 may again be supplied to the percolation plant 4 via conveying lines 14.2.5, 14.2.11.

The organically highly charged liquid 9.3 passing the screen 14.3.1 and accumulating at the bottom of the sink/float separation 14 is in accordance with FIG. 1 supplied to the biogas plant 9, wherein the fermentation water de-freighted of the organic matter is again supplied to the biogas plant 9 on the one hand as an absorptive washing water 9.4 of the percolation plant 4 or of the pulper plant 5, and on the other hand passes through the ultrafiltration 13 and the PCP plant 21, 22, 23, 2 as a partial flow 9.6.

FIG. 3 shows in detail a preferred PCP plant in accordance with the invention. The press water 16 of the ultrafiltration 13 is heated to the required process temperature in a heat exchanger 17. The heated press water 18 is admixed with a lye 19 in order to raise the pH value, so that ammonia is present in the press water 18 in a dissolved form. The mixed water 20 is treated in a stripper means 22 for separating ammonia gas from the water with an efficiency of about 90% by means of pre-heated air 22.2.

The stripper means 22 comprise a stripper column 22.1 into which the mixed water 20 is introduced in an upper area through spraying means 22.4. The mixed water 20 introduced by spraying flows downwards in the stripper column 22.1, wherein a filling body packing 22.6 is introduced into the stripper column 22.1 so as to enlarge the exchange surface. At the same time the mixed water 22 is passed through in a counter-flow by the heated air 22.2 introduced via a fresh air ventilator. Ideally the air 22.2 is heated to the same temperature as the mixed water 20 with the aid of a heat exchanger 22.7. The ammonia contained in the mixed water 20 is released by the pre-heated air conducted in a counter-flow and exits from the stripper column 22.1 as ammonia-laden waste air 22.3. The water 22.5 freed from the ammonia gathers at the bottom of the stripper column 22.1 and is supplied to a reverse osmosis 23. In order to achieve a stripping effect of about 90%, the pH of the mixed water 20 is advantageously raised to >10, and the temperature of the mixed water 20 and of the heated air 22.2 is adjusted to 60° C.

The waste air 22.3 is supplied to a catalyst column 22.8 in which the ammonia present in the form of a gas is decomposed and reduced to atmospheric nitrogen, and the hydrogen is oxidized into water. The catalyst column 22.8 is at the beginning pre-heated to the required operating temperature by means of a heating 22.9. If a sufficient quantity of ammonia is present in the waste air 22.3, the further process may unfold autothermally, i.e., the pollutants contained in the waste air 22.3 supply the required reaction heat. This is satisfied if the ammonia content in the press water 16 is at least about 2000 mg/l. If the ammonia content drops below this approximate limit value of 2000 mg/l, heat energy must be supplied.

The waste air 22.3 exits from the catalyst column 22.8 in the form of residual air 22.11 that is saturated with water vapor and charged with nitrogen. The residual air 22.11 is cooled in a cooler or condenser 22.12 and downstream from the latter discharged to the environment in the form of waste air 22.13 charged with nitrogen, N₂.

A proportion that is freed from ammonia exits from the catalyst column 22.8 in the form of a condensate 22.10 that is supplied to the reverse osmosis 23.

In the reverse osmosis 23, pollutants present in the water 22.5 of the stripper column 22.1 and in the condensate 22.10 of the catalyst column 22.8 are pressed through diaphragms inside a receptacle 23.1 by molecular diaphragm techniques with the aid of high-pressure means 23.2. The water molecules exit from the receptacle 23.1 in the form of a so-called permeate 23.5 practically free from salt. This permeate 23.5 may, for example, be partly used as the operating water 23.6 in the above described washing stage 14.2 or be admixed to the liquid 9.3 highly charged with organic matter that is introduced into the biogas plant 9 (FIGS. 1 and 6). The salt molecules and other pollutions exit from the receptacle 23.1 together with sewage 23.3 in the form of a concentrate 23.4. This concentrate 23.4 may subsequently be dried, e.g., by evaporation in a vacuum-boiling drying and then supplied to the further treatment 15.

In accordance with FIG. 3.1. it is also possible to sequentially arrange several stripper columns 22. When two stripper columns 22, 22′ are arranged sequentially, it is possible to reduce the ammonia load by 99%.

The mixed water 20 charged with ammonia is supplied to the first stripper column 22.1, and following a first purification step extracted in the form of water 22.5 that is freed from ammonia up to 90%. With the aid of a pump 22.5.1 this water 22.5 is supplied to the second stripper column 22.1′ and there subjected to a further purification step. The water 22.5′ freed from ammonia up to 99% subsequently arrives at the reverse osmosis 23. The waste air 22.3, 22.3′ charged with ammonia of the two stripper columns 22.1, 22.1′ is supplied to a catalyst column 22.8 as described above.

FIG. 4 shows a basic model of another embodiment of a PCP plant 21 for processing press water 16 having an ammonia content of about 2000 mg/l at the most, a chloride content of about 5000 mg/l, and a chemical oxygen demand (COD content) of about 2000 mg/l.

The press water 16 of the ultrafiltration 13 is heated in a heat exchanger 17 and supplied on the head side to a stripper column 21.1 in the form of heated mixed water 20 with an admixture of a lye 19 so as to raise the pH value. The mixed water 20 is sprayed in the stripper column 21.1 with the aid of spraying means 21.4 and moves downwards, while its substance exchange surface is enlarged with the aid of a filling body packing 21.6. At the same time, saturated vapor 21.2 generated, e.g., by means of a steam generator or of a waste vapor generator 21.7, is injected in a counter-flow. By the introduction of this vapor it is possible to reduce the ammonia in the mixed water 20 by up to 99%. The ammonia is washed out from the mixed water 20, and the charged waste vapor 21.3 is, supplied to cooling means 24 including a cooling or condenser column 24.1. The ammonia-laden waste vapor 21.3 is cooled, whereby an ammonia/water concentrate NH₄OH 24.2 including about 25% of ammonia is obtained. This concentrate 24.2 is received in a storage 24.3 and may—as mentioned under FIG. 1—be used for the denitrificaton of large-scale combustion plants 24.4 such as thermal power plants and waste incineration plants. In this case the ammonia is sprayed into the combustion and thus suppresses the formation of NO_{X}.

As an alternative, the concentrate 24.2 may also be dried, e.g. by evaporation in a vacuum-boiling drying, and subsequently be supplied to the further treatment 15.

The water vapor 24.5 separated out by condensation and substantially free from ammonia is discharged to the environment.

The water 21.5 freed from ammonia is extracted from the stripper column 21.1 on the bottom side and supplied to the above mentioned reverse osmosis 23.

FIG. 5 shows a combination of the basic models of FIGS. 3 and 4, wherein the ammonia load in the waste water is also reduced by up to 99%. In addition the occurring ammonia waste water concentrate 24.2 is reduced to a quantity that does not pose any problems in terms of disposal.

The combination includes two stripper means 22, 21 arranged in series. In the first stripper means 22—as is known from FIG. 3—heated air 21.2 is blown into the stripper column 21.1, and in the second stripper means 22—as is known from FIG. 4—a saturated vapor 21.2 is injected into the stripper column 21.1.

The waste air 22.3 charged with ammonia of the first stripper column 22.1 is supplied to a stripper catalyst 22.8. The water 22.5 freed from ammonia is mixed with the condensate 21.10 of the stripper catalyst 22.8 and supplied to the stripper column 21.1 of the second stripper means 21 in the form of mixed water 20.1 with the aid of a pump 22.5.1.

The waste vapor 21.3 charged with ammonia from the second stripper column 21.1 is in accordance with the above description supplied to the pooling means 24 and condensed there. The water 21.5 charged with ammonia is in the above described manner supplied to the reverse osmosis 23.

FIG. 6 shows a model process of a residual waste processing including essentially a percolation plant 4 or a pulper plant 5 and a substances separation and processing plant 10, 14 for the liquid 9.3 that occurs in the washing processes 4, 5, is enriched with dissolved organic matter and residual raw materials, and supplied to a hybrid reactor 9 in accordance with the invention.

In known biogas plants the liquid 9.3 is fermented in fully mixed and one- to two-stage stirring vessel reactor, wherein the organic matter is converted into biogas. As a stirring mechanism customarily a mechanical agitating system or a gas-injection circulation system is used. The dwell time of the liquid 9.3 in a like stirring vessel reactor is about 18 to 24 days.

In contrast with these known solutions, a dwell time of about 2 days to 4 days is sufficient in the hybrid reactor 9 in accordance with the invention. Moreover it is advantageous in the solution of the invention that by the pre-treatment stage having the form of the sink/float separation 14 (cf. FIG. 2) the liquid 9.3 discharged from the pulper plant 5 may also be supplied to the hybrid reactor 9, for this pre-treatment stage 14 sufficiently filters out the solids from the liquid 9.3.

The hybrid reactor 9 comprises an insulated cylindrical receptacle 9.1. On the bottom side the pre-treated liquid 9.3 is injected through injection means 9.3.3 across the cross-section of the receptacle 9.1 such that an approximate rising velocity of 2 m/h results. The organic constituents solved out from the injected liquid 9.3.2 by means of methane bacteria sink downwards in the hybrid reactor 9 and there form a bed of sludge 9.2.1. The bed of sludge 9.2.1 serves as a fermentation stage and reaction bed for precipitating, e.g., inert substances, chlorides, and phosphates. By means of sludge discharge means 9.8 a discharge sludge 9.10 including an admixture of precipitated inert substances and salts is discharged from the receptacle 9.1. Precipitation is supported with the aid of a precipitation agent 9.7 that is admixed to the liquid 9.3 prior to entry into the hybrid reactor 9.

In order to support the conversion of substances, i.e., for an enhanced decomposition of methane gas and for enhanced purification of the liquid 9.3.2 charged with organic matter, the methane bacteria are arranged in a filling body packing or in a solid bed 9.2 consisting of a bulk material or block elements. The enhancement of the substance conversion is predominantly brought about by an increase of the reaction surfaces and an immobilization of the active bacteria sludge. The reaction surfaces amount to approximately 200 m²/m³ to 300 m²/m³.

The sludge discharge means 9.8. comprise at least one sliding floor means 9.8.1 including scraping elements and at least one worm conveyor 9.8.3. The sliding floor means 9.8.1 are represented as a piston rod of a hydraulic cylinder/piston unit 9.8.2 on which the scraping elements are mounted. In each extension movement of the piston rod, i.e., a movement to the right in FIG. 6, the discharge sludge 9.10 is conveyed to the worm conveyor 9.8.3. By means of a valve 9.8.4 an outlet from the worm conveyor 9.8.3 may be closed.

The liquid freed from the organic constituents is extracted overhead from the receptacle 9.1 and supplied in the form of the washing water 9.4 to the percolation plant 4 or to the pulper plant 5, as well as in the form of a partial flow 9.6 to the ultrafiltration 13 with a subsequent PCP plant 21, 22, 23,24.

In order to avoid the formation of a surface scum of floating matter 9.11.1, a horizontal stirring mechanism 9.11 is provided closely underneath the surface of the injected liquid 9.3.2 accumulated in the receptacle 9.1. The horizontal stirring mechanism 9.11 may be replaced with a vertical stirring mechanism or the like.

In order to subject the bed of sludge 9.2.1 and the filling body packing 9.2 to shear forces, gas 9.14.2 is periodically injected by means of a ventilator or a compressor 9.15 via a tubing 9.14 and gas injection nozzles 9.14.1. Preferably this gas is taken from the biogas supplied to the biogas combustion. Such an injection of gas has the effect that the formation of channels in the filling body packing 9.2 is suppressed and old, dead bacteria sludge is solved out from the filling body packing 9.2 to either float to the surface as a floating matter 9.11.1 or be discharged together with the discharge sludge 9.10 as a sinking matter depending on its weight.

In order to withdraw, sulfur from the biogas, a desulfurization chamber 9.12 is provided in the head, into which air or oxygen 9.13.2 is injected by means of a ventilator 9.13 that includes a throughput control. In order to prevent explosions of the biogas/air mixture, the proportion of air is 2.0% at the most. Thanks to this injection of air, the sulfur in the biogas is precipitated in the form of elemental sulfur 9.13.1 and forms the surface scum 9.11.1 on the surface. The elemental sulfur 9.13.1 is not soluble any more and sinks downwards in the hybrid reactor 9, where it is discharged together with the discharge sludge 9.10.

A partial flow 9.6 is branched off from the washing water 9.4 and supplied to the ultrafiltration 13. Following the ultrafiltration 13, the press water 16 having an ammonia content of about 1000 mg/l to 3000 mg/l is supplied to the PCP plant 21, 22, 23, 24, denitrified there in accordance with the preceding description (FIGS. 3, 3.1. 4 and 5), and again admixed to the charged liquid 9.3 in the form of a denitrified operating water 23.6.

A solids/water mixture 16.1 having a DS content of about 4% to 8%, which occurs in the ultrafiltration 13, is supplied to the further treatment 15 in the form of a press cake 16.2 and/or also admixed to the liquid 9.3 that is highly charged with organic matter, as an inoculating sludge 16.3 for the hybrid reactor 9.

Moreover the partial flow 9.6 serves as circuit water 9.5 for adjusting the operating: temperature. The circuit water 9.5 is heated in a heat exchanger 9.5.1 and mixed with the organic matter-laden liquid 9.3.

FIG. 7 shows an alternative basic model of a process in accordance with FIGS. 1 and 6 for the processing of residual waste, comprising a biogas plant 9′ with an upstream sand settling and precipitation reactor 25. The upstream arrangement of a like reactor 25 has the advantage that the sand settling and precipitation process does not unfold in the hybrid reactor 9 so that it is possible to do away with sludge discharge means 9.8 that are costly in terms of construction.

It was found in trials that the sand settling time is about 1 h, and the precipitation time 5 min at the most. Thus the size and geometry of the receptacle 25.1 are designed for a stay time of at least one hour.

The sand settling and precipitation reactor 25 comprises a cylindrical receptacle 25.1 including a submersible wall 25.2 for the forced introduction of a liquid flow into the receptacle 25.1. The submersible wall 25.2 extends from a receptacle cover in the direction of a bottom-side, worm-type discharge means 25.4 wherein a passage for the liquid flow is formed between the submersible wall 25.2 and the discharge means 25.4.

The liquid 9.3 charged with organic matter is mixed with a precipitation agent 9.7 and supplied to the receptacle 25.1. The liquid 9.3 flows around the submersible wall 25.2, with the sand and the precipitated products such as, e.g., chlorides and phosphates accumulating on the receptacle bottom and being discarded by the discharge means 25.4 in the form of discharge sludge 9.10.

The liquid 9.3.1 freed from the sand and the precipitated products is extracted on the head side from the receptacle 25.1 and supplied to the hybrid reactor 9 for the further processing as described above.

Instead of the partition wall 25.2 it is also possible to use mixing means or combine the latter with the partition wall 25.2. The mixing means may be particularly advantageous with heavy metals, for the latter require a longer contact period. In addition a mixing mechanism may be provided in the supply to the receptacle 25.1.

FIG. 8 shows an alternative for the waste processing including a percolation plane 4 or a pulper plant 5. The process represented there is based on the use of a dry fermentation plant 6. Accordingly this model process does not include a hybrid reactor 9 in accordance with the invention.

The fermentation plant 6 comprises a fermentation receptacle for carrying out a fermentation process with exclusion of air, i.e., anaerobic fermentation. Such a fermentation receptacle is used, e.g., in systems of the Swiss company Kompogas AG (www.kompogas.ch), the Austrian Baustoff and Recycling Verband (BAV, www.brv.at), Dranko, and the French company Valora Int. SAS (www.steinmuller-valorga.fr).

In the case of Kompogas and BRV, the sifting fraction or fresh waste 3.1 is introduced into the mechanical processing 3 of the organically charged substances 1 while admixing inoculation material 6.4 taken from the fermentation process by inoculating it with anaerobic bacteria, and after dilution with process water 10.2 is introduced into the fermentation receptacle by means of a pump and conveyor means 6.3 via a head-side feed line 6.5. The fermenter contents 6.7 are periodically circulated with the aid of a stirring mechanism 6.1 and transported to an outlet at the bottom by a mechanical effect. The process heat is maintained with the aid of an external jacket heating (not shown) and a heat exchanger in the feed line 6.5 (not shown).

In Dranko and Valorga, just like in the plants according to Kompogas and BRV, the fresh waste 3.1 is inoculated and diluted by admixing the inoculation material 6.4. and process water 10-2, and introduced via the feed line 6.5 into the fermentation receptacle and circulated by means of pump and conveyor means 6.3.

Other than in the case of Kompogas and BRV, the fermentation receptacle 6 in Dranko/Valorga has the form of a cylindrical, erect element in steel or concrete construction while not having any mechanical stirring mechanism in interior. In Dranko, circulation is performed by the pump and conveyor means 6.3 exclusively. In Valorga, circulation is performed with the aid of a gas injection system with injection lances 6.2 near the bottom whereby the fermenter contents 6.7 are subjected to pressure pulses of >8 bar.

The process temperature in Dranko and Valorga is adjusted by means of an external jacket heating and a heat exchanger in the pump and conveyor means 6.3 and the feed line 6.5, respectively, as well as direct blowing in of steam into the fresh waste 3.1.

The anaerobic biogas generation from the fermentation process in accordance with the fermentation plant 6 takes place in the fermentation receptacle, wherein the generated biogas is conducted overhead through the gas generation line 7 to the gas combustion 8.

From this biogas having a methane content of about 55% to 65%, heat and electricity may be generated with the aid of a block-type thermal power station. As an alternative, the biogas may be supplied to a direct combustion, or by a special gas processing with methane enrichment a gaseous vehicle fuel may be obtained.

Following a stay time of at least 18 days in Kompogas and 25 days at the most in Valorga, the fermenter contents 6.7 exit from the fermentation receptacle in the form of a fermentation cake 6.6 and are supplied to at least two separating stages 10, 11 in order to generate a treatable waste water.

The first separating stage is customarily a classing press 10 wherein the press cake 12 is separate from the waste water 10.1 charged with organic matter and added to the further treatment 15. The waste water 10.1 mostly has a DS content of >12% and is supplied to a second separating stage 11. A partial flow of the waste water 10.1 is admixed to the fresh waste 3.1 an process water 10.2.

The second separating stage may also be a classing press 11. The press cake 12.1. of the second separating stage 11 may also be added to the further treatment 15. The waste water 11.1 of the second separating stage 11 is supplied to an ultrafiltration 13 in the manner described at the outset.

The solids/water mixture 16.1 from the ultrafiltration 13 is mixed as a press cake 16.2 with the press cake 12, 12.1 of the upstream separating stages 10, 11 and supplied to the further treatment 15. Here the mixture may have a DS content of 35% to 45%. The press water 16 of the ultrafiltration 13, having a DS content of 5% at the most, is supplied for purification and denitrification to the PCP plant 21, 22, 23, 24 of the invention (FIGS. 3, 3.1, 4, 5).

Preliminary trials showed that at particular residual waste compositions it is possible to use a process for processing the occurring substance flows, which is simplified in comparison with the model process in accordance with FIG. 2. Such a simplified process is represented in FIG. 9. With regard to the mechanical processing 3, the percolation or pulper plant 4, 5, and the classing press 10, this process substantially corresponds to the embodiment described in FIG. 2, so that a repeated explanation of these separating stages is not necessary.

The waste water 10.1 present after the classing press 10 as well as the discharge water 4.3 occurring in a percolation are in the simplified process supplied not to the separation tank 14.1 but directly to the washing stage 14.2. The sand 14.2.2 contained in the waste water 10.1 and in the discharge water 4.3 sinks downwards in the vessel, while the organic constituents 14.2.1 float to the top and are discharged as an organic matter/operating water mixture 14.2.3.

Washing out of the organic matter takes is performed with the aid of operating or communal water 23.6 if clean sand 14.2.9 is demanded. Where the Sand may be laden with organic pollutions, the waste water 9.3 from the sifting stage 14.3 that is purified of fibrous substances and sand and charged with organic matter is used as washing water, which is supplied to the biogas reactor 9 for the production of biogas

The sand 14.2.2 freed from organic matter is extracted via the discharge and conveying means 14.2.8 and in the form of a substance flow 14.2.9 (more or less freed from organic matter depending on the used washing agent) either used as a construction material or the like, or subjected to the further treatment 15 depending on the setting of the valve of the flow deflector/mixer 14.1.12.

The organic matter/operating water mixture 14.2.3 is supplied to the sifting stage or floating/fibrous substance separation 14.3. To this stage 14.3 the liquid flow 14.2.3 charged with organic matter and press water 14.3.3 from a classing press 14.3.2 arranged downstream from the sifting stage 14.3 that is recycled via the conveying line 14.2.5 are supplied. The proportion of the press water 14.3.3 supplied to the sifting stage 14.3 is in turn adjusted via a flow deflector/mixer 14.1.12. This press water may alternately or simultaneously also be supplied to the washing stage 14.2 or to the percolator 4 or the pulper plant 5.

By means of the sifting stage 14.3 line the one employed in the model process in accordance with FIG. 2, the water freed from sand and sinking matter and charged with organic matter is freed from fibrous and floating matter by means of a screen (drum or oscillating screen) having gap/mesh widths of 0.5 to 1.5 mm. This pasty mass 14.2.10 is dewatered by means of the above mentioned classing press 14.3.2 and optionally either separately grasped by the substance deflector 14.1.12 or supplied to the further treatment 15. The press water 14.3.3 is—in accordance with the above explanations and depending on the degree of pollution—optionally recycled to the sifting stage 14.3, the washing stage 14.2, or the percolation 4 or pulper plant 5 via the conveying lines 14.2.5.

The organically charged liquid 9.3 occurring at the bottom of the sifting stage 14.3 and largely freed from solids is then in the described manner supplied to the biogas plant 9 or partly recycled to the washing stage.

The single components for process water processing may be combined at will. The applicant reserves the right to direct respective independent claims to the single apparatus (14.1, 14.2, 14.3, 9, 21, 22, 23, 24, 25), as well as the combinations thereof and the plants in accordance with FIGS. 1-9.

What is disclosed is a process for mechanical and biological processing of waste substances, in particular of residual waste, wherein a physico-chemical processing (PCP) for the denitrificaton of a process water freed from organic constituents is provided as well as a hybrid reactor comprising a solid bed, sludge discharge means, and means for destroying a surface scum.

### LIST OF REFERENCE SYMBOLS

1 organically charged substances
2 direct supply
3 processing plant
3.1 sifting step, fresh waste
3.2 screen overflow
3.3 means for sifting and sorting steps
4 percolation plant
4.1 stirring mechanism
4.2 sieve bottom
4.3 discharge water
4.4 solids
4.5 receptacle
5 pulper plant
5.1 stirring mechanism
5.2 discharge means
5.3 light-density materials
5.4 solids
5.5 pulper vessel
5.7 residual flow
6 fermentation plant
6.1 stirring mechanism
6.3 pump and conveyor means
6.4 inoculation material
6.5 feed line
6.6 fermentation cake
6.7 fermenter contents
7 gas generation line
8 biogas combustion
9 biogas plant, hybrid reactor
9′ biogas plant with upstream Sandabsatzreaktor
9.1 receptacle
9.2 filling body packing, solid bed
9.2.1 bed of sludge
9.3 liquid charged with organic matter
9.3.2 injected liquid.
9.3.3 injection means
9.4 washing water freed from organic matter
9.5 circuit water
9.5.1 heat exchanger
9.6 partial flow
9.7 precipitation means
9.8 sludge discharge means
9.8.1 sliding floor means
9.8.2 cylinder/piston unit
9.8.3 worm conveyor
9.8.4 valve
9.10 discharge sludge
9.11 horizontal stirring mechanism
9.11.1 floating matter
9.12 desulfurization chamber
9.13 fan
9.13.1 elemental sulfur
9.13.2 air, oxygen
9.14 tubing
9.14.1 gas injection nozzles
9.14.2 gas
9.15 fan, compressor
10 classing press
10.1 waste water
10.2 process water
11 classing press
11.1 waste water
12 press cake
12.1 press cake
13 decanter, screen belt press, ultrafiltration, filtration plant (mechanical edge filter)
14 sink/float separation
14.1 separation tank
14.1.1 floating matter
14.1.10 conveying line
14.1.11 waste water, liquid flow
14.1.12 flow deflector/mixer (valve)
14.1.2 sinking matter
14.1.3 mechanical means
14.1.4 fan
14.1.5 mixer
14.1.6 injection means
14.1.7 conveying line
14.1.9 conveying line
14.2 washing stage
14.2.1 organic constituents and floating matter
14.2.2 sand and heavy matter
14.2.3 organic matter/operating water mixture, liquid flow floating matter
14.2.4 conveyor means
14.2.5 conveying like
14.2.6 introduction means
14.2.7 introduction line
14.2.8 discharge and conveying means
14.2.9 sand freed from organic matter
14.2.10 pasty mass
14.2.11 conveying line
14.3 sifting stage
14.3.1 drum or oscillating screen
14.3.2 classing press for floating and fibrous substances
14.3.3 press water
14.3.5 dewatered floating and fibrous substances
15 further treatment
16 press water
16.1 solids/water mixture
16.2 press cake
16.3 inoculating sludge
17 heat exchanger
18 is heated press water
19 lye
20 mixed water
20.1 mixed water
21 stripper means
21.1 stripper column
21.2 saturated vapor
21.3 waste vapor charged with ammonia
21.4 spraying means
21.5 water freed from ammonia
21.6 filling body packing
21.7 steam generator, waste vapor generator
22 stripper means
22′ second stripper means
22.1 stripper column
22.1′ second stripper column
22.2 air
22.3 waste air
22.3′ ammonia-laden waste air
22.4 spraying means
22.5 water freed from ammonia
22.5 water
22.5.1 pump
22.6 filling body packing
22.7 heat exchanger
22.8 catalyst column
22.9 heating
22.10 condensate
22.11 residual air
22.12 condenser
22.13 waste air charged with nitrogen
23 reverse osmosis
23.1 receptacle
23.2 high-pressure means
23.3 solid
23.4 concentrate
23.5 permeate
23.6 operating water
24 cooling means
24.1 cooling or condenser column
24.2 ammonia water concentrate
24.3 storage
24.4 use for denitrificaton in large-scale combustion plants
24.5 amonia-free water vapor
25 sand sedimentation and precipitation reactor
25.1 receptacle
25.2 partition wall
25.3 sand, precipitated products
25.4 discharge means

1. A process for the processing of waste substances, in particular of residual waste, comprising
a mechanical processing of the residual waste
a biological processing of the residual waste, by supplying process water (10.2, 9.4, 14.2.11) for dissolving and/or discharging organic constituents, and
processing the process water (4.3, 14.1.10, 14.1.11) charged with organic matter by separating off organic constituents from the process water (4.3, 14.1.10, 14.1.11),
characterized in that
the process water processing step contains a physico-chemical processing (PCP; 21, 22, 23, 24) for denitrificaton of the process water (9.6) freed from organic constituents.

2. The process in accordance with claim 1, wherein the PCP includes at least one stripper means (21, 22, 22′) for separating out ammonia gas dissolved in the process water (16).

3. The process in accordance with claim 2, wherein the process water (20) is injected into a stripper column (22, 22′) and there subjected to the injection of air in a counter-flow.

4. The process in accordance with claim 3, comprising a catalyst column (22.8) for converting the ammonia gases into nitrogen and water.

5. The process in accordance with claim 2, wherein the process water (20.1) is injected into a stripper column (21) and there subjected to the injection of saturated vapor in a counter-flow.

6. The process in accordance with claim 5, comprising a cooler (24) for converting the ammonia gases into nitrogen and water.

7. The process in accordance with any one of claims 2 to 6, wherein stripper means with introduction of air (22) are arranged in series with second stripper means with introduction of air (22′) or stripper means with injection of saturated vapor (21).

8. The process in accordance with claim 2 to 7, wherein lye (19) is added to the process water (18) upstream from the stripper means (21, 22, 22′).

9. The process in accordance with any one of the preceding claims, wherein the PCP includes a reverse osmosis (23) for separating out pollutants, salts, etc.

10. The process in accordance with any one of the preceding claims, wherein the biological processing takes place in a percolation plant (4), a pulper plant (5), or in a fermentation plant (6).

11. The process in accordance with claim 10, wherein an ultrafiltration (13) of the process water (9.6) precedes the PCP plant (21, 22, 23 24).

12. The process in accordance with any one of the preceding claims, wherein the processing of the process water (9.3) includes a precipitation of chlorides, phosphates, etc.

13. The process in accordance with any one of the preceding claims, wherein the biological processing of the process water (9.3) takes place in a hybrid reactor (9) including a solid bed (9.2) which comprises sludge discharge means (9.8) and/or means (9.11) for destroying a surface scum.

14. The process in accordance with claim 13, comprising means (9.13) for the injection of air/oxygen (9.13.2) into the head of the hybrid reactor (9).

15. The process in accordance with claim 13 or 14, wherein the hybrid reactor (9) includes means for pressing in gas (9.15) so as to periodically subject a forming bed of sludge (9.2.1) and the solid bed (9.2) to shear forces.

16. The process in accordance with claim 13, 14 or 15, wherein the forming biogas is desulfurized in a desulfurization chamber (9, 12) of the hybrid reactor (9).

17. The process in accordance with a combination containing claims 11 and 12, wherein a part of the solids/water mixture (16.1) occurring in the ultrafiltration (13) is added to the precipitation in a downstream location as inoculating sludge (16.3).

18. The process in accordance with any one of the preceding claims, wherein the processing of the process water (4.3) contains a flotation separation (14) for discharging solids.

19. The process in accordance with any one of the preceding claims, wherein the processing of the process water (14.1.10) contains a sand washing stage (14.2) upstream from the biological process water processing and/or a sifting stage (14.3) for separating out floating and fiber substances.

20. The process in accordance with any one of the preceding claims, wherein a sand sedimentation and precipitation plant (25) for the sedimentation of micro-fine sand and for the precipitation of phosphates, inert substances, etc. is arranged downstream from the sand washing (14).

21. A hybrid reactor, in particular for performing the process in accordance with any one of the preceding claims, comprising a solid bed (9.2), sludge discharge means (9.8), and means (9.11) for destroying a surface scum.

22. The hybrid reactor comprising a desulfurization chamber (9.12) and injection means (9.13) for injecting air/oxygen for a desulfurization of the forming biogas.
